(19) United States
(12) Patent Application Publication
(10) Pub. No.: US 2004/0085541 A1
(43) Pub. Date: May 6, 2004

(54) Method for recognizing objects

(75) Inventor: Otto Goernemann, Kaarst (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 10/649,379

(22) Filed: Aug. 26, 2003

(30) Foreign Application Priority Data
Aug. 28, 2002 (DE) 102 39 468.7

(51) Int. Cl. G01B 9/02

(52) U.S. Cl. 356/450

(57) ABSTRACT

A method for the contactless recognition of objects in a monitored region uses coherent light. Light reflected by the object is made use of by employing an interference pattern.

### BACKGROUND OF THE INVENTION

This invention relates to a method for the contactless recognition of objects in a monitored region by illuminating the object with light.

The term “object” is to be understood in its broadest sense. Thus, and by way of example only, an object can be an article or product or an area, space or surroundings that need to be monitored.

The term “light” should also be understood in its most general sense and is not limited to visible light. Instead, the term “light” includes any kind of electromagnetic radiation, any type of ultraviolet (UV) light, infrared (IR) light, as well as visible light as far as it is useful in the context of the present invention for recognizing objects.

Methods for recognizing objects serve a control function, for example when monitoring a region or surrounding. When certain changes are detected, a signal is generated which constitutes a safety signal for purposes of protecting against accidents or an alarm signal for control or monitoring purposes. Another aspect of the present invention relates to the recognition of materials or characteristics for the purpose of recognizing an object. Here too the surroundings can be monitored. If in this region a previously defined or learned object is sensed, the system generates a signal that can be used in a control system.

A disadvantage of conventional sensing technologies is that the sensor, when only a signal sensor is used, cannot recognize three-dimensional shapes, surroundings or regions. Presently available cameras and camera sensors provide the receiver with only a two-dimensional picture of the monitored region or surroundings. This limits the ability to distinguish objects because not all characteristic features of the object can be made use of. As a result, such systems lead to a partially unreliable object recognition which diminishes the functionality of such systems.

### SUMMARY OF THE INVENTION

It is an object of the present invention to provide an improved method for the contactless recognition of objects in a monitored region with an improved object recognition capability. Broadly speaking, this is attained by directing coherent light onto the object and analyzing the light reflected by the object by generating an interference pattern.

The result is a holographic safety system that can contactlessly recognize objects in a monitored region. Holographic techniques allow the optical system to perform several functions. For one, the system can provide a monitoring function for the three-dimensional monitoring of surroundings or a region. When predetermined changes are detected, a signal is generated which can be used as a safety signal for purposes of preventing accidents or as an alarm signal for control and monitoring purposes. In addition, the present invention enables the recognition of materials and/or object characteristics. Here too the surroundings are three-dimensionally monitored by the system. If a previously defined or learned object is detected in the monitored region, the system generates a corresponding signal which can be used by a control unit.

An advantage provided by the systems of the present invention in comparison to conventional sensors which use cameras and/or camera sensors is that the present invention provides a two-dimensional display of a three-dimensional surrounding. Such displays are easily stored and readily and quickly accessible. The present invention leads to an improved recognition of and distinction between objects because several characteristics, such as surface configuration, surface size, as well as spatial orientation, are recognizable and can be used. This leads to a more reliable recognition of objects due to fewer error readings and a resulting enhanced efficiency of the system.

The present invention operates as follows. Objects are principally recognized in accordance with the invention by a holographic system that comprises an emitter light source, a receiver and a signal processor. The light source emits coherent light at one or more wave lengths (that is, a single-color or multicolor light), preferably laser light in the visible red or infrared spectrum. The light is focused in the desired location by directing it past appropriate optics, such as lens systems. Light focused in this manner illuminates the surroundings for the desired, even illumination of the area or areas of interest, e.g. an object. The illuminated object sends so-called Huygens elementary waves from every illuminated point on its surface. The totality of these elementary waves form the wave that is reflected by the illuminated object. The amplitude and phase of the resulting wave front carries object surface information that can be evaluated with an interference pattern of the wave front.

Another aspect of the invention is directed to attaining an even illumination of the monitored region. This can involve the use of electro-optical means such as rotatable, pivotal and/or micro mirrors, further lenses and prism systems, as well as diffraction gratings.

In one embodiment, the reflected light is used by employing an interference pattern. The entire wave reflected by the monitored region or object is captured by receiving optics and is diffracted with corresponding coherent light. The resulting interference pattern can be projected onto a line or surface sensitive sensor (preferably CMOS, but can also be of the CCD design). The received interference pattern can then be compared with a previously generated, stored interference pattern in a signal processor for generating the signal for recognizing an object, monitoring a region and/or protecting against accidents. The reference wave can come from a reference light source, or it may constitute a partial beam of the light emitted by the emitter light source.

In another embodiment, the light reflected by the object is compared to an interference pattern (reference hologram) involving a holographic correlation process. In this case, a sample is taken (for example of a correct or acceptable object, of surroundings in the proper order, etc.) and a hologram thereof is produced on a light sensitive surface of a photosensitive material. For controlling a monitored region or surroundings, the reference wave used in the earlier described embodiment of the invention is omitted and the received wave is instead projected onto the previously described reference hologram. This results in a wave that simulates the reference wave and can be focused on a light sensitive receiver. The amplitude of the resulting signal is a measurement of the deviation. This embodiment is particularly suitable for applications requiring fast comparisons.

### BRIEF DESCRIPTION OF THE DRAWINGS

FIG. 1 is a schematic view of a first embodiment of the invention using a reference wave; and

FIG. 2 shows a second embodiment that uses a reference hologram.

### DESCRIPTION OF THE PREFERRED EMBODIMENTS

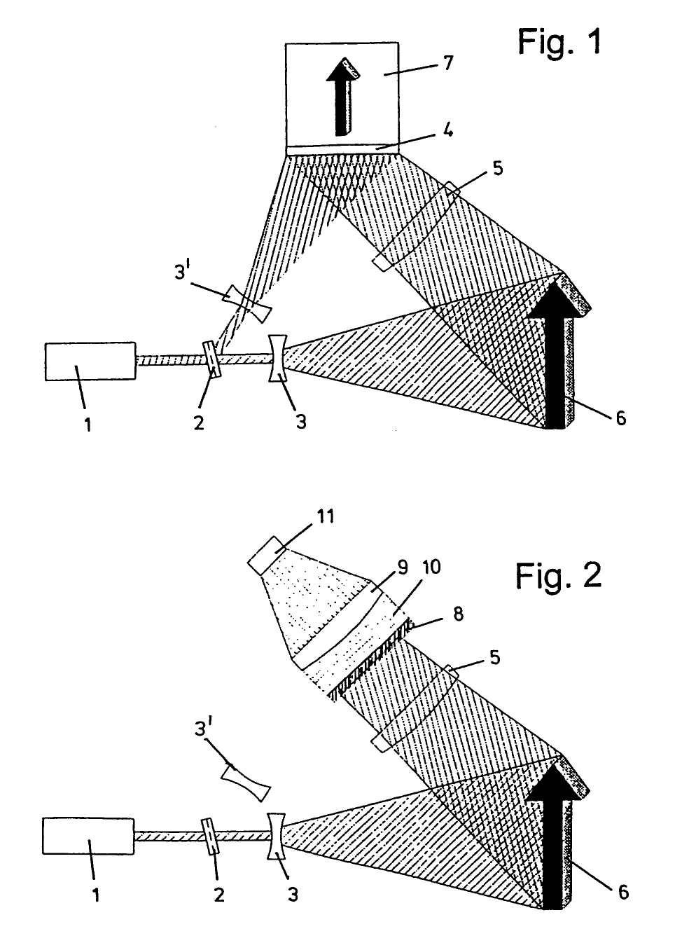

FIG. 1 shows a first embodiment of the invention for recognizing objects which includes a light source 1 that emits coherent light. A beam splitter 2 and two collimators 3, 3′ are downstream from light source 1. Collimator 3 is for the emitted beam (from the light source) and collimator 3′ is for a reference beam. The system further includes a receiver 4, which, for example, can be a detector or an image (picture) receiving surface, that is downstream of another optical system 5.

The system functions as follows:

Light source 1 emits monochromatic or multicolor, coherent light. The light is directed through a beam splitter 2 and collimator 3 and strikes an object 6. The surface of object 6 generates and reflects so-called Huygens elementary waves, and optical system 5 focuses these waves on receiver 4. Beam splitter 2 diverts a portion of the light beam from light source 1 and directs the light past collimator 3′ onto receiver 4. Together with light reflected by object 6, an interference pattern is generated which is used by processing electronics 7 and, preferably, is compared with a stored, reference interference pattern.

A second embodiment of the invention is shown in FIG. 2 and also has a light source 1 and a collimator 3. Beam splitter 2 and collimator 3′ are not used. The system further has a preestablished reference hologram 8 in the form of a desired interference pattern. The reference hologram 8 is downstream of an optical system 5 and upstream of an additional optical system 9.

The second embodiment of the invention functions as follows:

Coherent light generated by light source 1 strikes and is reflected by object 6. The reflected light is projected onto reference hologram 8. The resulting diffraction generates a wave 10 which corresponds to the reference wave of the holographic system employed in the first embodiment of the invention shown in FIG. 1. Optical system 9 focuses wave 10 onto a light sensitive receiver 11. The amplitude of the signal is a measurement of the deviation and can be used as such.

What is claimed is:

1. A method for the contactless recognition of an object in a monitored region comprising illuminating the object with coherent light and evaluating light reflected by the object by employing an interference pattern.

2. A method according to claim 2 including directing the coherent light through at least one of a beam splitter, a collimator and an optical system.

3. A method according to claim 1 including generating the interference pattern with the coherent light and the light reflected by the object, and comparing the interference pattern with a desired interference pattern.

4. A method according to claim 3 including providing the coherent light illuminating the object from one of a separate coherent light source and a beam splitter which diverts a portion of the coherent beam from the light source.

5. A method according to claim 1 including superimposing the reflected light over a desired interference pattern to thereby generate diffracted light, and measuring an intensity of the diffracted light.
